(19) United States
(12) Patent Application Publication
(10) Pub. No.: US 2020/0036882 A1
(43) Pub. Date: Jan. 30, 2020

(54) FASTER AUTOMATIC EXPOSURE CONTROL SYSTEM

(71) Applicant: QUALCOMM Incorporated, San Diego, CA (US)

(72) Inventors: Wenbin Wang, San Diego, CA (US); Loic Francois Segapelli, San Diego, CA (US); Ying Noyes, San Diego, CA (US)

(21) Appl. No.: 16/045,919

(22) Filed: Jul. 26, 2018

(51) Int. Cl. H04N 5/235; H04N 5/243

(52) U.S. Cl. CPC H04N 5/2353; H04N 5/243; H04N 5/2351

(57) ABSTRACT

Methods, systems, and devices for adjusting exposure at a camera of a device are described. The described techniques relate to improved methods, systems, devices, or apparatuses that support faster automatic exposure control (AEC). Generally, the described AEC techniques provide for alignment of exposure setting adjustments (e.g., exposure time adjustments, gain adjustments, etc.) with 2-frame gain adjustment delays. For example, gain adjustment calculations based on image sensor measurements associated with a current frame (e.g., frame N) may take into consideration exposure time adjustment calculations from the previous frame (e.g., frame N−1), such that AEC algorithms may use exposure time adjustment calculations from the previous frame (e.g., frame N−1) and gain adjustment calculations from the current frame (e.g., frame N) to adjust exposure settings with a 2-frame delay (e.g., such that updated exposure settings may take effect on frame N+2).

### BACKGROUND

The following relates generally to adjusting exposure at a camera of a device, and more specifically to faster automatic exposure control (AEC) systems.

A device may include an optical instrument (e.g., an image sensor, camera, etc.) for recording or capturing images, which may be stored locally, transmitted to another location, etc. For example, an image sensor may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the device.

In some examples, the size of the aperture and scene illumination (e.g., ambient lighting) may control the amount of light that enters the image sensor during a period of time (e.g., during a frame), and the shutter (e.g., exposure time) may control the length of time that the lens or optical instrument surface records light. As such, the total amount of light reaching the film plane (e.g., the ‘exposure’) may change with the duration of exposure (e.g., exposure time), aperture of the lens, the camera's analog gain, etc. Some cameras may be set or configured to adjust some or all of such controls automatically (e.g., using AEC techniques). For example, exposure time (e.g., line count) and gain settings may be updated periodically to adjust for conditions that may affect the visibility or discernibility of the information intended to be captured by the camera. In some cases, exposure adjustments associated with such AEC techniques may be associated with undesirable delays, as adjustments to exposure settings may lag compared to changing lighting conditions.

### SUMMARY

The described techniques relate to improved methods, systems, devices, or apparatuses that support faster automatic exposure control (AEC). Generally, the described AEC techniques provide for alignment of exposure setting adjustments with 2-frame gain adjustment delays. For example, gain adjustment calculations based on image sensor measurements associated with a current frame (e.g., frame N) may take into consideration exposure time adjustment calculations from the previous frame (e.g., frame N−1), such that AEC algorithms may use exposure time adjustment calculations from the previous frame (e.g., frame N−1) and gain adjustment calculations from the current frame (e.g., frame N) to adjust exposure settings with a 2-frame delay (e.g., such that updated exposure settings may take effect on frame N+2).

An image sensor (e.g., a camera) may measure a pixel brightness associated with a first frame (e.g., frame N−1) and signal one or more pixel values to a processor (e.g., an AEC component) based on the first frame pixel brightness measurement. The processor may determine a first exposure time adjustment parameter and a first gain adjustment parameter based on the pixel brightness measurement associated with the first frame. The image sensor may then measure a pixel brightness associated with a second frame (e.g., frame N) and signal one or more pixel values to the processor based on the second frame pixel brightness measurement. The processor may determine an updated gain adjustment parameter based on the pixel brightness measurement associated with the second frame and the first exposure time adjustment parameter. The processor may then determine updated or adjusted exposure settings for the image sensor (e.g., for pixel brightness measurements associated with a subsequent frame) based on the updated gain adjustment parameter and the first exposure time adjustment parameter.

A method of adjusting exposure at a camera (e.g., camera exposure) is described. The method may include measuring a pixel brightness associated with a first frame, determining a first exposure time adjustment parameter and a first gain adjustment parameter based on the pixel brightness measurement associated with the first frame, measuring a pixel brightness associated with a second frame, determining an updated gain adjustment parameter based on the pixel brightness measurement associated with the second frame and the first exposure time adjustment parameter, and adjusting exposure settings associated with a third frame based on the first exposure time adjustment parameter and the updated gain adjustment parameter.

An apparatus for adjusting camera exposure is described. The apparatus may include a processor, memory in electronic communication with the processor, and instructions stored in the memory. The instructions may be executable by the processor to cause the apparatus to measure a pixel brightness associated with a first frame, determine a first exposure time adjustment parameter and a first gain adjustment parameter based on the pixel brightness measurement associated with the first frame, measure a pixel brightness associated with a second frame, determine an updated gain adjustment parameter based on the pixel brightness measurement associated with the second frame and the first exposure time adjustment parameter, and adjust exposure settings associated with a third frame based on the first exposure time adjustment parameter and the updated gain adjustment parameter.

Another apparatus for adjusting exposure at a camera of a device is described. The apparatus may include means for measuring a pixel brightness associated with a first frame, determining a first exposure time adjustment parameter and a first gain adjustment parameter based on the pixel brightness measurement associated with the first frame, measuring a pixel brightness associated with a second frame, determining an updated gain adjustment parameter based on the pixel brightness measurement associated with the second frame and the first exposure time adjustment parameter, and adjusting exposure settings associated with a third frame based on the first exposure time adjustment parameter and the updated gain adjustment parameter.

A non-transitory computer-readable medium storing code for adjusting exposure at a camera is described. The code may include instructions executable by a processor to measure a pixel brightness associated with a first frame, determine a first exposure time adjustment parameter and a first gain adjustment parameter based on the pixel brightness measurement associated with the first frame, measure a pixel brightness associated with a second frame, determine an updated gain adjustment parameter based on the pixel brightness measurement associated with the second frame and the first exposure time adjustment parameter, and adjust exposure settings associated with a third frame based on the first exposure time adjustment parameter and the updated gain adjustment parameter.

In some examples of the method, apparatuses, and non-transitory computer-readable medium described herein, determining the updated gain adjustment parameter further may include operations, features, means, or instructions for determining a second gain adjustment parameter based on the pixel brightness measurement associated with the second frame, determining a ratio of the first exposure time adjustment parameter and the second exposure time adjustment parameter and multiplying the second gain adjustment parameter by the ratio, where the updated gain adjustment parameter includes a result of the multiplication.

Some examples of the method, apparatuses, and non-transitory computer-readable medium described herein may further include operations, features, means, or instructions for measuring a pixel brightness associated with the third frame, determining a second updated gain adjustment parameter based on the pixel brightness measurement associated with the third frame and adjusting exposure settings associated with a fourth frame based on the second updated gain adjustment parameter and the first exposure time adjustment parameter.

Some examples of the method, apparatuses, and non-transitory computer-readable medium described herein may further include operations, features, means, or instructions for determining a second exposure time adjustment parameter based on the pixel brightness measurement associated with the second frame and adjusting exposure settings associated with a fourth frame based on the second exposure time adjustment parameter and the updated gain adjustment parameter.

In some examples of the method, apparatuses, and non-transitory computer-readable medium described herein, adjusting the exposure settings associated with the third frame further may include operations, features, means, or instructions for determining, by a processing component, the first exposure time adjustment parameter during the first frame, determining, by the processing component, the updated gain adjustment parameter during the second frame and determining, by the processing component, one or more exposure setting values for the third frame based on the first exposure time adjustment parameter and the updated gain adjustment parameter, where the exposure settings may be adjusted based on the one or more determined exposure setting values.

Some examples of the method, apparatuses, and non-transitory computer-readable medium described herein may further include operations, features, means, or instructions for signaling, by the processing component, the one or more determined exposure setting values to the camera of the device, where the camera adjusts the exposure settings for the third frame based on the one or more determined exposure setting values.

In some examples of the method, apparatuses, and non-transitory computer-readable medium described herein, the one or more exposure setting values include a gain value, an exposure time value, or both.

Some examples of the method, apparatuses, and non-transitory computer-readable medium described herein may further include operations, features, means, or instructions for signaling, by the camera, one or more pixel values to the processor based on the pixel brightness measurement associated with the first frame and the pixel brightness measurement associated with the second frame, where the first exposure time adjustment parameter and the updated gain adjustment parameter may be determined by the processor based on the one or more pixel values.

### BRIEF DESCRIPTION OF THE DRAWINGS

FIG. 1 illustrates an example of a system for adjusting exposure at a camera of a device that supports faster automatic exposure control (AEC) in accordance with aspects of the present disclosure.

FIG. 2 illustrates an example of a timing diagram that supports faster AEC in accordance with aspects of the present disclosure.

FIG. 3 illustrates an example of a process flow that supports faster AEC in accordance with aspects of the present disclosure.

FIG. 4 shows a block diagrams of a device that supports faster AEC in accordance with aspects of the present disclosure.

FIG. 5 shows a diagram of a system including a device that supports faster AEC in accordance with aspects of the present disclosure.

FIGS. 6 through 8 show flowcharts illustrating methods that support faster AEC in accordance with aspects of the present disclosure.

### DETAILED DESCRIPTION

Automatic exposure control (AEC) techniques (e.g., AEC algorithms) may use gain information, exposure time (e.g., line count) information, and brightness measurements (e.g., pixel values associated with measured frames) to adjust camera exposure settings. In some cases, AEC processing timelines may result in exposure setting adjustments (e.g., exposure time adjustments and gain adjustments) being associated with varying delays. For example, gain adjustments may be associated with a 2-frame delay (e.g., gain adjustments determined from a frame N may not take effect until a frame N+2) and exposure time adjustments may be associated with a 3-frame delay (e.g., exposure time adjustments determined from a frame N may not take effect until a frame N+3). To account for such varying delays, AEC algorithms may align the timing of exposure setting adjustments on the longest delay. For example, to ensure AEC delivers exposure settings in time, AEC may adjust exposure settings according to a 3-frame delay associated with the longer exposure time adjustment delays. As such, AEC may calculate gain and/or exposure time settings based on a frame N, and the camera may implement the settings three frames later, on frame N+3. In some cases, it may be undesirable to align exposure setting adjustments with longer delays, as adjustments to exposure settings may lag compared to changing lighting conditions.

The techniques described herein may provide for faster AEC. Generally, the described AEC techniques provide for alignment of exposure setting adjustments (e.g., exposure time adjustments, gain adjustments, etc.) with 2-frame gain adjustment delays. For example, gain adjustment calculations based on image sensor measurements associated with a current frame (e.g., frame N) may take into consideration exposure time adjustment calculations from the previous frame (e.g., frame N−1), such that AEC algorithms may use exposure time adjustment calculations from the previous frame (e.g., frame N−1) and gain adjustment calculations from the current frame (e.g., frame N) to adjust exposure settings with a 2-frame delay (e.g., such that updated exposure settings may take effect on frame N+2).

An image sensor (e.g., a camera) may measure a pixel brightness associated with a first frame (e.g., frame N−1) and signal one or more pixel values to a processor (e.g., an AEC component) based on the first frame pixel brightness measurement. The processor may determine a first exposure time adjustment parameter and a first gain adjustment parameter based on the pixel brightness measurement associated with the first frame. The image sensor may then measure a pixel brightness associated with a second frame (e.g., frame N) and signal one or more pixel values to the processor based on the second frame pixel brightness measurement. The processor may determine an updated gain adjustment parameter based on the pixel brightness measurement associated with the second frame and the first exposure time adjustment parameter. The processor may then determine updated or adjusted exposure settings for the image sensor (e.g., for pixel brightness measurements associated with a subsequent frame) based on the updated gain adjustment parameter and the first exposure time adjustment parameter.

That is, for a current frame (e.g., a frame N), AEC techniques may update exposure settings with a 2-frame delay based on an updated gain value determined from the current frame and an exposure time adjustment determined from a previous frame. In some cases, exposure time adjustments may be calculated for each frame, such that for a given current frame N, exposure time adjustments determined from the preceding frame N−1 may be used for exposure setting adjustments taking effect on frame N+2. For example, a first exposure time adjustment parameter may have been determined based on frame N−1 and a second exposure time adjustment parameter may be determined based on a current frame N. An updated gain adjustment parameter may be determined by multiplying a gain adjustment parameter (e.g., determined from the current frame N) by a ratio of the first and second exposure time adjustment parameters. The exposure settings for the frame N+2 may then be based on the updated gain adjustment parameter (e.g., determined at frame N) and the first exposure time parameter (e.g., determined at frame N−1). In other cases, exposure time adjustments may be calculated less frequently (e.g., once for a group of frames), such that for a given current frame N, some semi-static exposure time adjustment determined from some preceding frame may be used for exposure setting adjustments taking effect on frame N+2. For example, for a series of frames, some initial or semi-static exposure setting adjustment may be used along with updated gain adjustment parameters (e.g., that may be updated for each current frame N), for exposure setting adjustments (e.g., taking effect on each frame N+2).

Aspects of the disclosure are initially described in the context of an AEC system. Example timing diagrams and process flows illustrating the described AEC techniques are then discussed. Aspects of the disclosure are further illustrated by and described with reference to apparatus diagrams, system diagrams, and flowcharts that relate to faster AEC

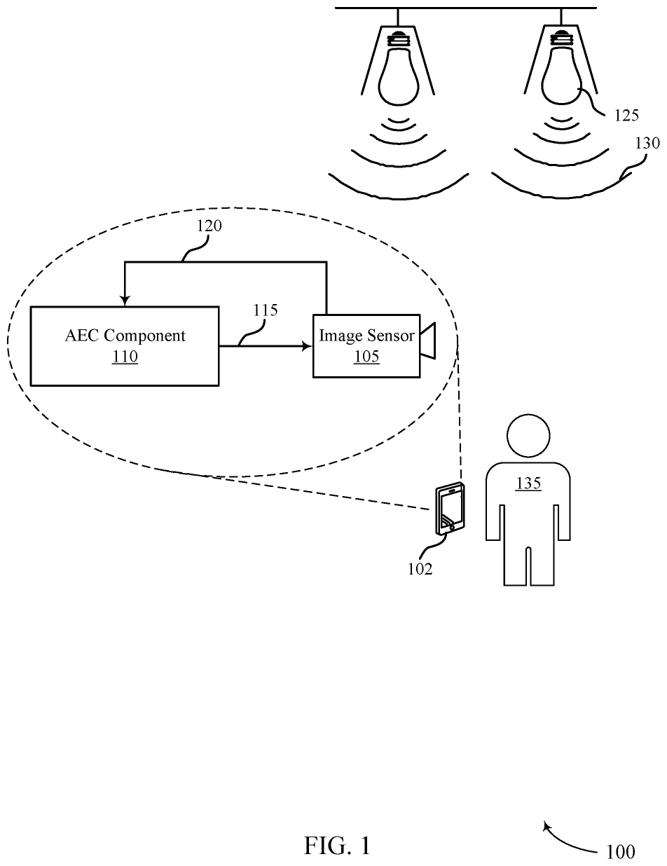

FIG. 1 illustrates an example of a system 100 (e.g., an AEC system) that supports faster AEC in accordance with aspects of the present disclosure. System 100 may include a device 102 that includes an image sensor 105 (e.g., a camera) in electronic communication with an AEC component 110 (e.g., some AEC software or AEC algorithm processor). System 100 may illustrate a user 135 of the device 102 in a lighting environment including associated with light sources 125 and light 130. Pixel brightness measurements (e.g., of or based on light 130) taken by the image sensor 105 (e.g., pixel values associated with a picture taken by a camera) may vary as the user 135 aims the image sensor 105 in different directions, as the user 135 moves relative to the various light sources 125. etc. Techniques described with reference to aspects of system 100 are done so for exemplary purposes only, and are not intended to be limiting in terms of the applicability of the described techniques. That is, the techniques described may be implemented in, or applicable to, other examples of environments with varying lighting and/or other examples of image sensor or camera based applications, without departing from the scope of the present disclosure.

As used herein, a device 102 may be stationary or mobile (e.g., undergoing some motion). A device 102 may also be referred to as a mobile device, a wireless device, a remote device, a handheld device, a subscriber device, or some other suitable terminology. A device 102 may also be a personal electronic device such as a cellular phone, a personal digital assistant (PDA), a tablet computer, a laptop computer, a personal computer, or a display device (e.g., any device with a camera, image sensor, light sensor, etc.). In some examples, a device 102 may also refer to an Internet of Things (IoT) device, an Internet of Everything (IoE) device, a machine type communication (MTC) device, a peer-to-peer (P2P) device, or the like, which may be implemented in various articles such as appliances, vehicles, meters, or the like. Further examples of devices 102 that may implement one or more aspects of faster AEC techniques may include Bluetooth devices, personal data assistants (PDAs), hand-held or portable computers, netbooks, notebooks, smartbooks, tablets, printers, copiers, scanners, facsimile devices, cameras, camcorders, webcams, computer monitors, cockpit controls and/or displays, camera view displays (such as the display of a rear-view camera in a vehicle), etc.

Any of such devices may include at least one light sensor (e.g., image sensor 105) that outputs a signal, or information bits, indicative of light 130 (e.g., an intensity of light 130, an amount of light 130, red green blue (RGB) values associated with light 130, etc.). For example, image sensor 105 may signal or pass such information to AEC component 110 over link 120. In response to that signal, exposure settings may be varied or adjusted by, for example, one or more driver circuits, such as AEC component 110. For example, AEC component 110 may signal or pass exposure setting adjustments (e.g., updated exposure time values, updated gain values, etc.) to image sensor 105 over link 115. AEC component 110 may refer to a general central processing unit (CPU), a dedicated piece of hardware, a system on chip (SoC), etc. In some cases, the image sensor 105 may be mounted on a frame of the device 102 near, but not on, a cover glass of the device's display. Further, the device 102 may include electrical connections associated with the image sensor 105, the one or more drivers (e.g., the AEC component 110), the display, etc., and may provide connections between the image sensor and AEC component 110 circuit (e.g., and in some cases also between a display). In some examples, a general processor of the device may perform aspects of the AEC component 110.

For example, a pixel brightness measurement or a pixel value from an image sensor 105 may correspond to a pixel intensity value, RGB values of a pixel, or any other parameter associated with light 130 (e.g., or the image being captured, the picture being taken, etc.). An image sensor 105 may include at least one photosensitive element. The photosensitive element may have a sensitivity to a spectrum of electromagnetic radiation (e.g., including at least the visible spectrum of electromagnetic radiation). For example, the at least one photosensitive element may be tuned for sensitivity to a visible spectrum of electromagnetic radiation (e.g., by way of depth of a photodiode depletion region associated with the photosensitive element), and the exposure settings of the image sensor 105 may be adjusted to improve image visibility, discernibility, etc. in different light conditions. The image sensor 105 may output a signal representative of at least one characteristic of the measured pixel brightness (e.g., of the light 130 measurement) such as, for example, an intensity value or RGB values of measured light. In some cases, image sensor 105 may refer to an electronic image sensor such as a charged coupled device (CCD) or a complementary metal-oxide-semiconductor (CMOS) sensor to capture images which can be transferred or stored for processing. In some cases, examples described below may be discussed in terms of a pixel brightness measurement. It should be understood the described techniques may be applied to a series or combination of several pixel brightness measurements (e.g., as generally associated with image capture) by analogy without departing from the scope of the present disclosure.

Image sensor 105 (e.g., a camera) may measure a pixel brightness associated with a first frame (e.g., frame N−1) and signal one or more pixel values to a processor (e.g., to AEC component 110 over link 120) based on the first frame pixel brightness measurement. The AEC component 110 may determine a first exposure time adjustment parameter and a first gain adjustment parameter based on the pixel brightness measurement associated with the first frame. The image sensor 105 may then measure a pixel brightness associated with a second frame (e.g., frame N) and signal one or more pixel values to the AEC component 110 (e.g., over link 120) based on the second frame pixel brightness measurement. The AEC component 110 may determine an updated gain adjustment parameter based on the pixel brightness measurement associated with the second frame and the first exposure time adjustment parameter. The AEC component 110 may then determine updated or adjusted exposure settings for the image sensor 105 (e.g., for pixel brightness measurements associated with a subsequent frame) based on the updated gain adjustment parameter and the first exposure time adjustment parameter. The AEC component 110 may then adjust the exposure settings of image sensor 105 (e.g., the AEC component 110 may signal an updated exposure time value and/or an updated gain value to image sensor 105 over link 115). The image sensor 105 may use the updated exposure settings for capturing a subsequent frame (e.g., for measuring and reporting pixel brightness associated with a subsequent frame N+2).

The AEC component 110 may adjust the exposure settings of image sensor 105 based on pixel brightness measured and signaled (e.g., to the AEC component 110) by the image sensor 105, as well as current settings. For example, AEC component 110 may read input brightness stats (e.g., pixel brightness reported by image sensor 105) and current exposure settings, and may calculate updated exposure settings for a next frame. Exposure settings may refer to exposure time (e.g., or line count) settings and gain settings. An exposure may refer to the amount of time the sensor receives light within one frame (e.g., the duration within the measurement frame for which the photosensitive element captures or receives light). For example, in some cases, image sensor 105 may use lines as a unit of time, and may refer to time in terms of how fast a line may be read out. A gain setting may refer to a multiplier that digitally amplifies the light level received at the image sensor (e.g., increasing gain may raise the intensity of the entire pixel brightness signal indicated by the image sensor 105). In some cases, exposure may be proportional to exposure time multiplied by gain (e.g., exposure∝(exposure time)*(gain)), and the exposure settings may be applied to each pixel brightness measurement taken during a frame. For example, AEC component 110 may be responsible for maintaining pixel brightness within an acceptable range. When pixels are too dark, AEC component 110 may increase exposure, when pixels are too bright, AEC component 110 may decrease exposure.

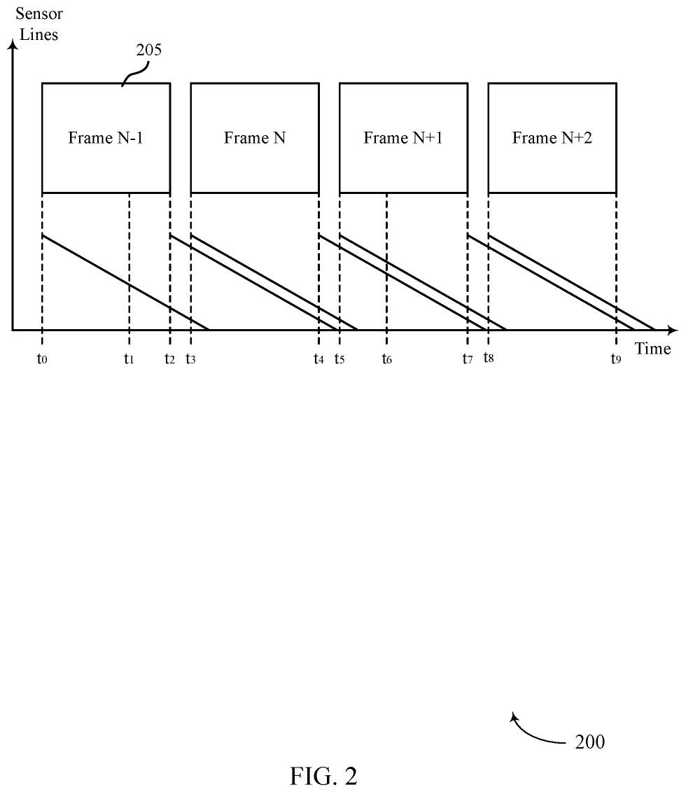

FIG. 2 illustrates an example of a timing diagram 200 that supports faster AEC in accordance with aspects of the present disclosure. In some examples, timing diagram 200 may implement aspects of system 100. Timing diagram 200 may illustrate AEC processing and exposure setting adjustment for a series of frames 205.

The device may adjust the exposure settings of a camera (e.g., image sensor) based on pixel brightness measurements and current exposure settings. For example, an AEC component may read input brightness stats (e.g., pixel brightness measurements reported by an image sensor), and may calculate updated exposure settings for a next frame based on current exposure settings. As discussed above, exposure settings may include exposure time settings and gain settings. AEC may be slowed down due to timing constraints associated with the AEC processing timeline.

For example, image sensor exposure time adjustments may take effect before first row exposure begins for a given frame. That is, the exposure time settings may not be updated after first row exposure has begun (e.g., exposure time adjustments may need to be implemented before pixel brightness measurements have started for a frame). In some cases, “reset” may refer to the image sensor event that resets the pixel value and begins or restarts light integration (e.g., for a first row of photosensitive elements or pixels). For example, at t₀ a first reset event may occur where the pixel values of an image sensor may be reset, and light integration may begin for frame N−1. Times t₃, t₅, and t₈ may correspond to reset events, where light integration begins for frame N, frame N+1, and frame N+2, respectively. In some case, exposure time (e.g., exposure time adjustments) may need to be set before a reset event, as the exposure time for a frame may need to be set before light integration for the frame begins.

Further, image sensor gain adjustments may be implemented before read-out begins. In some cases, “read-out” may refer to the image sensor event where an analog pixel value is converted into a digital value (e.g., where the amount of light affecting a photosensitive element is converted into a digital value). For example, at t₂ a first read-out event may occur where pixel brightness measurements associated with frame N−1 may be read-out and converted into a digital value (e.g., into a pixel value). Times t₄, t₇, and t₉ may correspond to read-out events, where pixel brightness measurements (e.g., for frame N, frame N+1, and frame N+2, respectively) are converted to digital values (e.g., and passed or signaled to an AEC component). In some cases, a read-out event may be referred to as gathering or identifying frame statistics. In some cases, gain (e.g., gain adjustments) may need to be set before a read-out event, as the gain for pixel brightness measurement may need to be taken into account before the read-out, such that the digital value resulting from the read-out accounts for (e.g., is multiplied by) the gain setting.

As discussed above, AEC may be slowed down due to timing constraints associated with the AEC processing timeline, and exposure setting adjustments (e.g., exposure time adjustments and gain adjustments) may be associated with varying delays. For example, due to long integration times, exposure time adjustments may not be applied until three frames later. Further, gain adjustments determined from frame N−1 (e.g., gain adjustments determined from the read-out at t₂) may not be applied until frame N+1 (e.g., two frames later).

According to techniques described herein, for a current frame (e.g., a frame N), AEC techniques may update exposure settings with a 2-frame delay based on an updated gain value determined from the current frame and an exposure time adjustment determined from a previous frame. For example, at t₁, an AEC component may pre-calculate an exposure time setting (e.g., an updated exposure time value, or an exposure time adjustment) for frame N+2 (e.g., ET_{N+2}). ET_{N+2} may be determined and stored for frame N+2. At t₄, frame statistics may be gathered for frame N (e.g., the image sensor may read-out pixel brightness measurements for frame N to AEC component). At t₆, AEC component may complete all exposure setting calculations for frame N (e.g., exposure time adjustment calculations for frame N+3 and gain adjustment calculations for frame N+2). As such, the AEC component may apply the gain adjustment for frame N+2 (e.g., G_{N+2}) at t₆. As discussed above, in some cases, G_{N+2} may be calculated as

$${G}_{N + 2} = \frac{{ET}_{N + 3}}{{ET}_{N + 2}} * AEC {gain}_{N + 2} .$$

Wherein ET_{N+3} is the exposure time setting calculated based on the read-out of frame N (e.g., at t₄), ET_{N+2} is the exposure time setting calculated based on the read-out of frame N−1 (e.g., at t₂), and AEC gain_{N+2} is the gain setting calculated based on the read-out of frame N (e.g., at t₄). In other examples, (e.g., where exposure time adjustments are not calculated for every frame) G_{N+2}=AEC gain_{N+2}, or G_{N+2} equals some ratio or weighted combination of AEC gain_{N+1} and AEC gain_{N+2}, as discussed in more detail above. Therefore, at t₉, updated gain adjustment parameter (e.g., G_{N+2}) and the exposure time adjustment parameter determined from frame N−1 (e.g., ET_{N+2}) may be applied and may take effect on frame N+2. As such, AEC exposure time/gain from frame N reflect on frame N+2, such that the system delay may be a 2-frame delay.

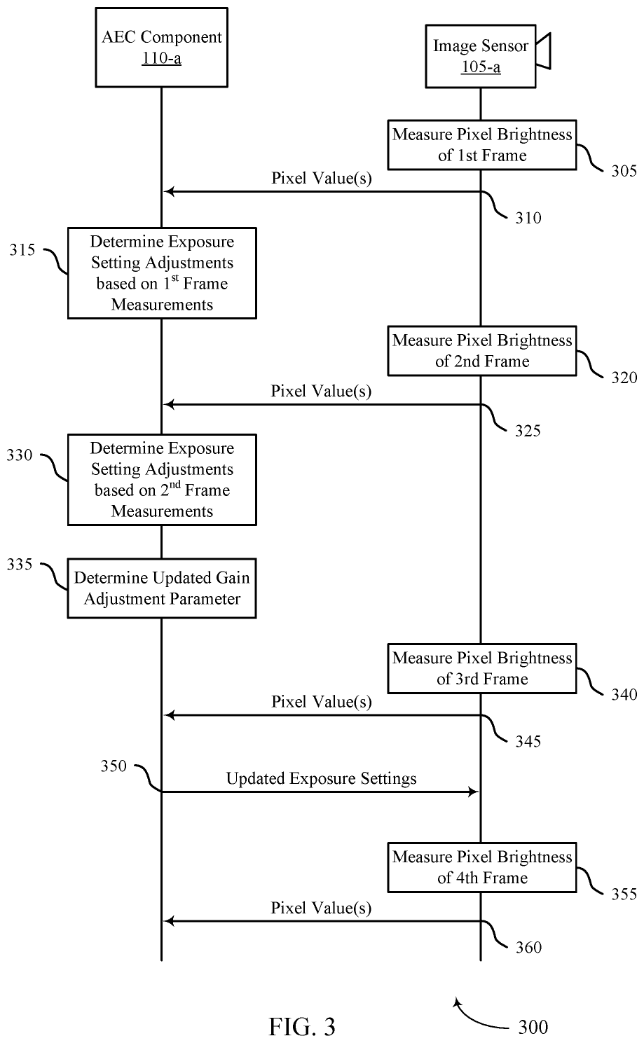

FIG. 3 illustrates an example of a process flow 300 that supports faster AEC in accordance with aspects of the present disclosure. In some examples, process flow 300 may implement aspects of system 100. Process flow 300 includes an image sensor 105-a and an AEC component 110-a, which may be examples of an image sensor 105 and AEC component 110 as described with reference to FIGS. 1 and 2. Process flow 300 may illustrate an AEC component 110-a adjusting or controlling brightness settings of image sensor 105-a. In the following description of the process flow 300, the passing of information between the image sensor 105-a and the AEC component 110-a may be performed in a different order than the exemplary order shown, or the operations performed by image sensor 105-a and AEC component 110-a may be performed in different orders or at different times. In some cases, certain operations may also be left out of the process flow 300, or other operations may be added to the process flow 300.

At 305, image sensor 105-a may measure a pixel brightness associated with a first frame (e.g., image sensor 105-a may measure brightness of one or more pixels of a frame N).

At 310, image sensor 105-a may signal (e.g., or pass) the one or more pixel values associated with the first frame (e.g., measured at 305) to AEC component 110-a. In some cases, the one or more pixel values may be conveyed via bits of information representing an intensity value associated with each pixel, RGB values associated with each pixel, etc.

At 315, AEC component 110-a may determine exposure setting adjustments (e.g., an exposure time adjustment parameter and a gain adjustment parameter) based on the one or more pixel brightness measurements associated with the first frame (e.g., based on the pixel values received at 310). For example, AEC component 110-a may identify frame statistics associated with the first frame (e.g., based on the information received at 310). The AEC component 110-a may then determine an exposure time adjustment parameter and/or a gain adjustment parameter for a subsequent frame (e.g., a fourth frame, or frame N+3) based on the frame statistics associated with the first frame (e.g., frame N).

At 320, image sensor 105-a may measure a pixel brightness associated with a second frame (e.g., image sensor 105-a may measure brightness of one or more pixels of a frame N+1).

At 325, image sensor 105-a may signal (e.g., or pass) the one or more pixel values associated with the second frame (e.g., measured at 320) to AEC component 110-a. In some cases, the one or more pixel values may be conveyed via bits of information representing an intensity value associated with each pixel, RGB values associated with each pixel, etc.

At 330, AEC component 110-a may determine exposure setting adjustments (e.g., an exposure time adjustment parameter and a gain adjustment parameter) based on the one or more pixel brightness measurements associated with the second frame (e.g., based on the pixel values received at 325). For example, AEC component 110-a may identify frame statistics associated with the second frame (e.g., based on the information received at 325). The AEC component 110-a may then determine an exposure time adjustment parameter and/or a gain adjustment parameter for a subsequent frame (e.g., a fifth frame, or frame N+4) based on the frame statistics associated with the second frame (e.g., frame N+1).

At 335, AEC component 110-a may determine an updated gain adjustment parameter (e.g., for exposure setting adjustments for the subsequent frame N+3). In some examples, AEC component 110-a may determine a ratio of a first exposure time adjustment parameter (e.g., determined at 315) and a second exposure time adjustment parameter (e.g., determined at 330). AEC component 110-a may then multiply the gain adjustment parameter determined at 330 (e.g., the gain adjustment parameter determined based on the second frame, frame N+1) by the ratio to determine or calculate the updated gain adjustment parameter.

In some cases, AEC component 110-a may less frequently determine exposure time adjustment parameters (e.g., AEC component 110-a may not determine a new exposure time adjustment parameter for each frame). In such cases, AEC component 110-a may determine exposure setting adjustments based on some semi-static exposure time adjustment parameter, as well as gain adjustment parameters that may be updated every frame. For example, exposure settings for a series of frames may be determined or adjusted based on a single (e.g., initial or preliminary) exposure time adjustment parameter, as well as gain adjustment parameters that are updated based on pixel brightness measurements for each frame. Therefore, in such cases, determining an updated gain adjustment parameter at 335 may refer to determining a new gain adjustment parameter based on pixel brightness measurements associated with the second frame (e.g., 330 and 335 may not be separate operations, and may be a same step), or determining an updated gain adjustment parameter at 335 may refer to determining an updated gain adjustment parameter based on the gain adjustment parameter determined at 315 and the gain adjustment parameter determined at 330 (e.g., the updated gain adjustment parameter may be determined based on some ratio or weighted combination of the first gain adjustment parameter and the second gain adjustment parameter).

At 340, image sensor 105-a may measure a pixel brightness associated with a third frame (e.g., image sensor 105-a may measure brightness of one or more pixels of a frame N+2).

At 345, image sensor 105-a may signal (e.g., or pass) the one or more pixel values associated with the third frame (e.g., measured at 340) to AEC component 110-a. In some cases, the one or more pixel values may be conveyed via bits of information representing an intensity value associated with each pixel, RGB values associated with each pixel, etc.

At 350, AEC component 110-a may adjust exposure settings associated with a fourth frame (e.g., frame N+3) based on the exposure time adjustment parameter associated with the first frame (e.g., determined at 315) and the updated gain adjustment parameter (e.g., determined at 335). For example, AEC component 110-a may signal (e.g., or pass) one or more determined exposure setting values (e.g., a gain value, exposure time value, or both) to image sensor 105-a. Image sensor 105-a may adjust exposure settings for the fourth frame based on the received (e.g., updated) exposure settings.

At 355, image sensor 105-a may measure a pixel brightness associated with the fourth frame (e.g., image sensor 105-a may measure brightness of one or more pixels of a frame N+3) based on the updated exposure settings. For example, image sensor 105-a may adjust the exposure time associated with the pixel brightness measurement, the gain associated with the readout of the pixel brightness measurements, or both (e.g., depending on the exposure settings received at 350).

At 355, image sensor 105-a may signal (e.g., or pass) the one or more pixel values associated with the fourth frame (e.g., measured at 355) to AEC component 110-a. In some cases, the one or more pixel values may be conveyed via bits of information representing an intensity value associated with each pixel, RGB values associated with each pixel, etc.

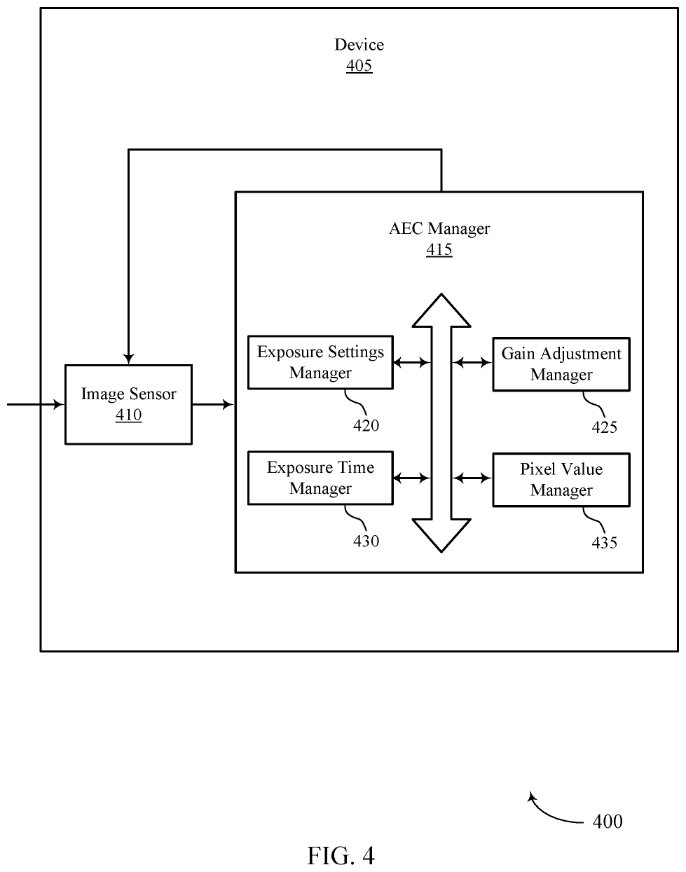

FIG. 4 shows a block diagram 400 of a device 405 that supports faster AEC in accordance with aspects of the present disclosure. The device 405 may be an example of aspects of a device as described herein. The device 405 may include an image sensor 410 and an AEC manager 415. The device 405 may also include a processor. Each of these components may be in communication with one another (e.g., via one or more buses).

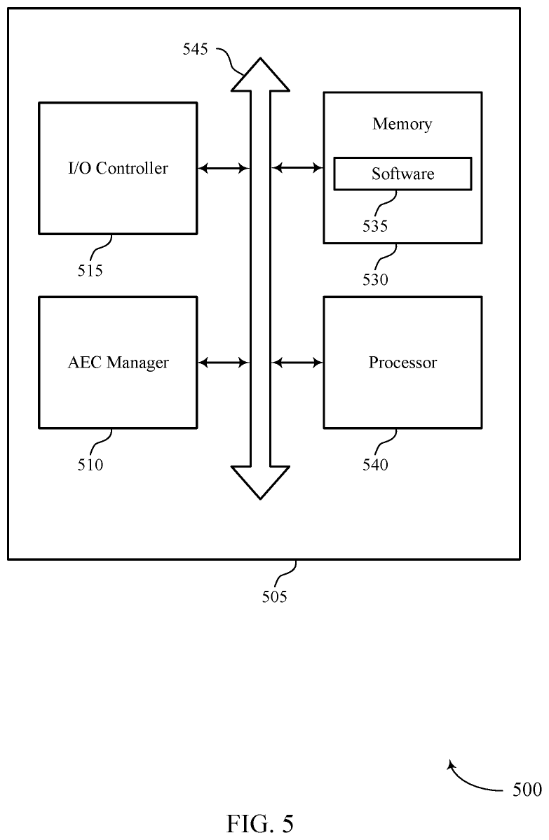

The image sensor 410 (e.g., a camera) may receive information (e.g., light), which may be passed on to other components of the device 405. In some cases, the image sensor 410 may be an example of aspects of the I/O controller 515 described with reference to FIG. 5. As discussed above, the image sensor 410 may utilize one or more photosensitive elements that have a sensitivity to a spectrum of electromagnetic radiation to receive such information (e.g., to receive a pixel intensity value, RGB values of a pixel, etc.). The image sensor 410 may thus measure pixel brightness associated with one or more frames. For example, the image sensor 410 may measure pixel brightness over a frame (e.g., over a frame duration). In the following example, the image sensor 410 may measure pixel brightness associated with a first frame (e.g., a frame N−1), a second frame (e.g., frame N), a third frame (e.g., frame N+2), a fourth frame (e.g., frame N+3), etc. The image sensor 410 may signal or pass the information (e.g., the one or more pixel values) to the pixel value manager 435 based on the pixel brightness measurement associated with the first frame and the pixel brightness measurement associated with the second frame.

In some cases, the AEC manager 415 may measure a pixel brightness associated with a first frame, measure a pixel brightness associated with a second frame, determine a first exposure time adjustment parameter and a first gain adjustment parameter based on the pixel brightness measurement associated with the first frame, adjust exposure settings associated with a third frame based on the first exposure time adjustment parameter and the updated gain adjustment parameter, and determine an updated gain adjustment parameter based on the pixel brightness measurement associated with the second frame and the first exposure time adjustment parameter. The AEC manager 415 may be an example of aspects of the AEC manager 510 described herein.

The AEC manager 415, or its sub-components, may be implemented in hardware, code (e.g., software or firmware) executed by a processor, or any combination thereof. If implemented in code executed by a processor, the functions of the AEC manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The AEC manager 415, or its sub-components, may be physically located at various positions, including being distributed such that portions of functions are implemented at different physical locations by one or more physical components. In some examples, the AEC manager 415, or its sub-components, may be a separate and distinct component in accordance with various aspects of the present disclosure. In some examples, the AEC manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The AEC manager 415 may include an exposure settings manager 420, a gain adjustment manager 425, an exposure time manager 430, and a pixel value manager 435. The AEC manager 415 may be an example of aspects of the AEC manager 510 described herein.

The exposure settings manager 420 may determine a first exposure time adjustment parameter and a first gain adjustment parameter based on (e.g., following) the pixel brightness measurement associated with the first frame. The gain adjustment manager 425 may determine an updated gain adjustment parameter based on the pixel brightness measurement associated with the second frame and the first exposure time adjustment parameter. In some cases, the gain adjustment manager 425 may determine a second gain adjustment parameter based on the pixel brightness measurement associated with the second frame. For example, the exposure time manager 430 may determine the first exposure time adjustment parameter during the first frame and may determine a second exposure time adjustment parameter based on the pixel brightness measurement associated with the second frame. The exposure time manager 430 may then determine a ratio of the first exposure time adjustment parameter and the second exposure time adjustment parameter. The gain adjustment manager 425 may then multiply the second gain adjustment parameter by the ratio to determine the updated gain adjustment parameter (e.g., the updated gain adjustment parameter may be the result of the multiplication).

As discussed above, the image sensor 410 may signal or pass the information (e.g., the one or more pixel values) to the pixel value manager 435 based on the pixel brightness measurement associated with the first frame, the pixel brightness measurement associated with the second frame, etc. The first exposure time adjustment parameter, the second exposure time adjustment parameter, the first gain adjustment parameter and the second gain adjustment parameter may be determined (e.g., by the gain adjustment manager 425 and the exposure time manager 430) based on the one or more pixel values.

The exposure settings manager 420 may adjust exposure settings associated with a third frame based on the first exposure time adjustment parameter and the updated gain adjustment parameter. For example, in some cases, the exposure settings manager 420 may determine one or more exposure setting values (a gain value, an exposure time value, or both) for the third frame based on the first exposure time adjustment parameter and the updated gain adjustment parameter, and adjust the exposure settings based on the one or more determined exposure setting values. The exposure settings manager 420 may signal the one or more determined exposure setting values to the camera of the device (e.g., to the image sensor 410), where the camera (e.g., the image sensor 410) may adjust the exposure settings for the third frame based on the one or more exposure setting values determined by the exposure settings manager 420.

In some examples, the exposure settings manager 420 may determine a second exposure time adjustment parameter based on the pixel brightness measurement associated with the second frame (e.g., frame N) and the gain adjustment manager 425 may determine a second updated gain adjustment parameter based on the pixel brightness measurement associated with the frame N+2. For example, the exposure time manager 430 may determine a third exposure time adjustment parameter during the frame N+1. The exposure time manager 430 may then determine a ratio of the second exposure time adjustment parameter and the third exposure time adjustment parameter. The gain adjustment manager 425 may then multiply the updated gain adjustment parameter (e.g., the first updated gain adjustment parameter used for exposure setting adjustments for frame N+2) by the ratio to determine the second updated gain adjustment parameter. In such examples, the exposure settings manager 420 may adjust exposure settings associated with a fourth frame (e.g., frame N+3) based on the second updated gain adjustment parameter and the second exposure time adjustment parameter.

In some examples, the exposure settings manager 420 may adjust exposure settings associated with the fourth frame (e.g., frame N+3) based on the second updated gain adjustment parameter and the first exposure time adjustment parameter. That is, in some examples, the exposure settings manager 420 may determine a (e.g., single) exposure time adjustment parameter, and may adjust exposure settings for subsequent frames based on the (e.g., single) exposure time adjustment parameter and continuously updated gain adjustment parameters (e.g., the AEC may utilize an initial exposure time adjustment parameter along with gain adjustment parameters updated each frame).

FIG. 5 shows a diagram of a system 500 including a device 505 that supports faster AEC in accordance with aspects of the present disclosure. The device 505 may be an example of or include the components of device 405 or other devices as described herein. In some cases, the device 505 may include components such as, for example, an AEC manager 510, an I/O controller 515, memory 530, and a processor 540. These components may be in electronic communication via one or more buses (e.g., bus 545).

The AEC manager 510 may measure a pixel brightness associated with a first frame, measure a pixel brightness associated with a second frame, determine a first exposure time adjustment parameter and a first gain adjustment parameter based on the pixel brightness measurement associated with the first frame, adjust exposure settings associated with a third frame based on the first exposure time adjustment parameter and the updated gain adjustment parameter, and determine an updated gain adjustment parameter based on the pixel brightness measurement associated with the second frame and the first exposure time adjustment parameter.

The I/O controller 515 may manage input (e.g., pixel intensity values and/or RGB values of a pixel at an image sensor) and output signals for the device 505. The I/O controller 515 may also manage peripherals not integrated into the device 505. In some cases, the I/O controller 515 may represent a physical connection or port to an external peripheral. In some cases, the I/O controller 515 may utilize an operating system such as iOS®, ANDROID®, MS-DOS®, MS-WINDOWS®, OS/2®, UNIX®, LINUX®, or another known operating system. In other cases, the I/O controller 515 may represent or interact with a modem, a keyboard, a mouse, a touchscreen, or a similar device. In some cases, the I/O controller 515 may be implemented as part of a processor. In some cases, a user may interact with the device 505 via the I/O controller 515 or via hardware components controlled by the I/O controller 515. In some cases, the I/O controller 515 may refer to an image sensor 105, and image sensor 410, a camera, a light sensor, etc.

The memory 530 may include RAM and ROM. The memory 530 may store computer-readable, computer-executable code or software 535 including instructions that, when executed, cause the processor to perform various functions described herein. In some cases, the memory 530 may contain, among other things, a BIOS which may control basic hardware or software operation such as the interaction with peripheral components or devices.

The processor 540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 540 may be configured to operate a memory array using a memory controller. In other cases, a memory controller may be integrated into the processor 540. The processor 540 may be configured to execute computer-readable instructions stored in a memory (e.g., the memory 530) to cause the device 505 to perform various functions (e.g., functions or tasks supporting faster AEC).

The software 535 may include instructions to implement aspects of the present disclosure, including instructions to support adjusting exposure at a camera of a device. The software 535 may be stored in a non-transitory computer-readable medium such as system memory or other type of memory. In some cases, the software 535 may not be directly executable by the processor 540 but may cause a computer (e.g., when compiled and executed) to perform functions described herein.

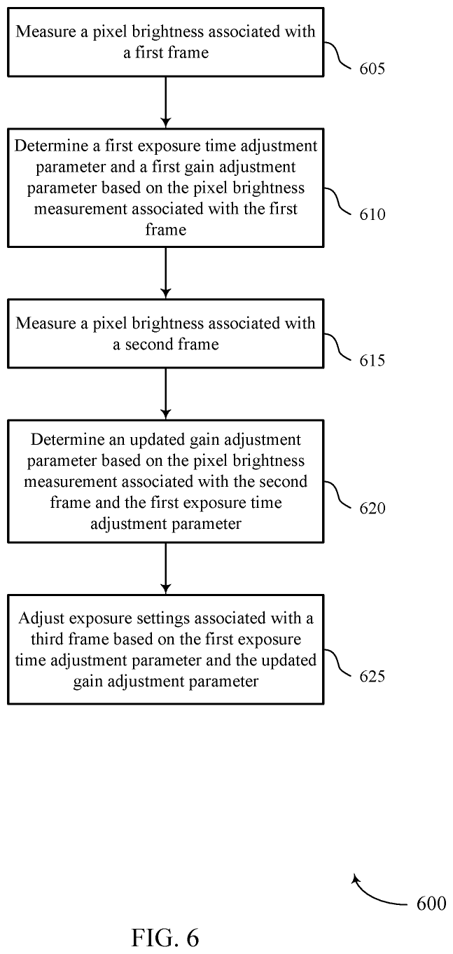

FIG. 6 shows a flowchart illustrating a method 600 that supports faster AEC in accordance with aspects of the present disclosure. The operations of method 600 may be implemented by a device or its components as described herein. For example, the operations of method 600 may be performed by an AEC manager as described with reference to FIGS. 4 through 5. In some examples, a device may execute a set of instructions to control the functional elements of the device to perform the functions described below. Additionally or alternatively, a device may perform aspects of the functions described below using special-purpose hardware.

At 605, the device may measure a pixel brightness associated with a first frame. The operations of 605 may be performed according to the methods described herein. In some examples, aspects of the operations of 605 may be performed by an image sensor as described with reference to FIGS. 4 through 5.

At 610, the device may determine a first exposure time adjustment parameter and a first gain adjustment parameter based on the pixel brightness measurement associated with the first frame. The operations of 610 may be performed according to the methods described herein. In some examples, aspects of the operations of 610 may be performed by an exposure settings manager as described with reference to FIGS. 4 through 5.

At 615, the device may measure a pixel brightness associated with a second frame. The operations of 615 may be performed according to the methods described herein. In some examples, aspects of the operations of 615 may be performed by an image sensor as described with reference to FIGS. 4 through 5.

At 620, the device may determine an updated gain adjustment parameter based on the pixel brightness measurement associated with the second frame and the first exposure time adjustment parameter. The operations of 620 may be performed according to the methods described herein. In some examples, aspects of the operations of 620 may be performed by a gain adjustment manager as described with reference to FIGS. 4 through 5.

At 625, the device may adjust exposure settings associated with a third frame based on the first exposure time adjustment parameter and the updated gain adjustment parameter. The operations of 625 may be performed according to the methods described herein. In some examples, aspects of the operations of 625 may be performed by an exposure settings manager as described with reference to FIGS. 4 through 5.

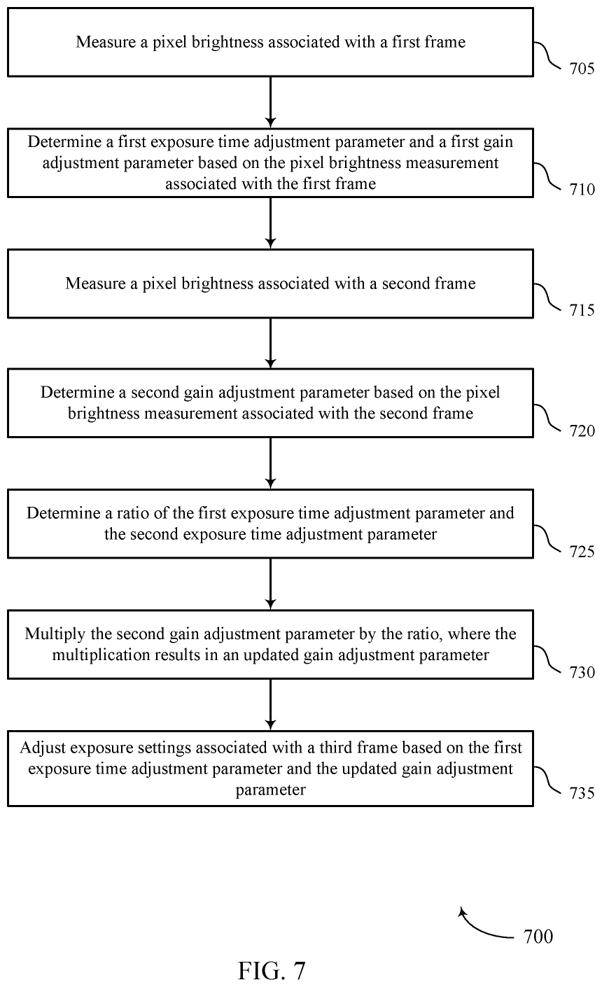

FIG. 7 shows a flowchart illustrating a method 700 that supports faster AEC in accordance with aspects of the present disclosure. The operations of method 700 may be implemented by a device or its components as described herein. For example, the operations of method 700 may be performed by an AEC manager as described with reference to FIGS. 4 through 5. In some examples, a device may execute a set of instructions to control the functional elements of the device to perform the functions described below. Additionally or alternatively, a device may perform aspects of the functions described below using special-purpose hardware.

At 705, the device may measure a pixel brightness associated with a first frame. The operations of 705 may be performed according to the methods described herein. In some examples, aspects of the operations of 705 may be performed by an image sensor as described with reference to FIGS. 4 through 5.

At 710, the device may determine a first exposure time adjustment parameter and a first gain adjustment parameter based on the pixel brightness measurement associated with the first frame. The operations of 710 may be performed according to the methods described herein. In some examples, aspects of the operations of 710 may be performed by an exposure settings manager as described with reference to FIGS. 4 through 5.

At 715, the device may measure a pixel brightness associated with a second frame. The operations of 715 may be performed according to the methods described herein. In some examples, aspects of the operations of 715 may be performed by an image sensor as described with reference to FIGS. 4 through 5.

At 720, the device may determine a second gain adjustment parameter and a second exposure time adjustment parameter based on the pixel brightness measurement associated with the second frame. The operations of 720 may be performed according to the methods described herein. In some examples, aspects of the operations of 720 may be performed by a gain adjustment manager as described with reference to FIGS. 4 through 5.

At 725, the device may determine a ratio of the first exposure time adjustment parameter and the second exposure time adjustment parameter. The operations of 725 may be performed according to the methods described herein. In some examples, aspects of the operations of 725 may be performed by an exposure time manager as described with reference to FIGS. 4 through 5.

At 730, the device may multiply the second gain adjustment parameter by the ratio, where the multiplication results in an updated gain adjustment parameter. The operations of 730 may be performed according to the methods described herein. In some examples, aspects of the operations of 730 may be performed by a gain adjustment manager as described with reference to FIGS. 4 through 5.

At 735, the device may adjust exposure settings associated with a third frame based on the first exposure time adjustment parameter and the updated gain adjustment parameter. The operations of 735 may be performed according to the methods described herein. In some examples, aspects of the operations of 735 may be performed by an exposure settings manager as described with reference to FIGS. 4 through 5.

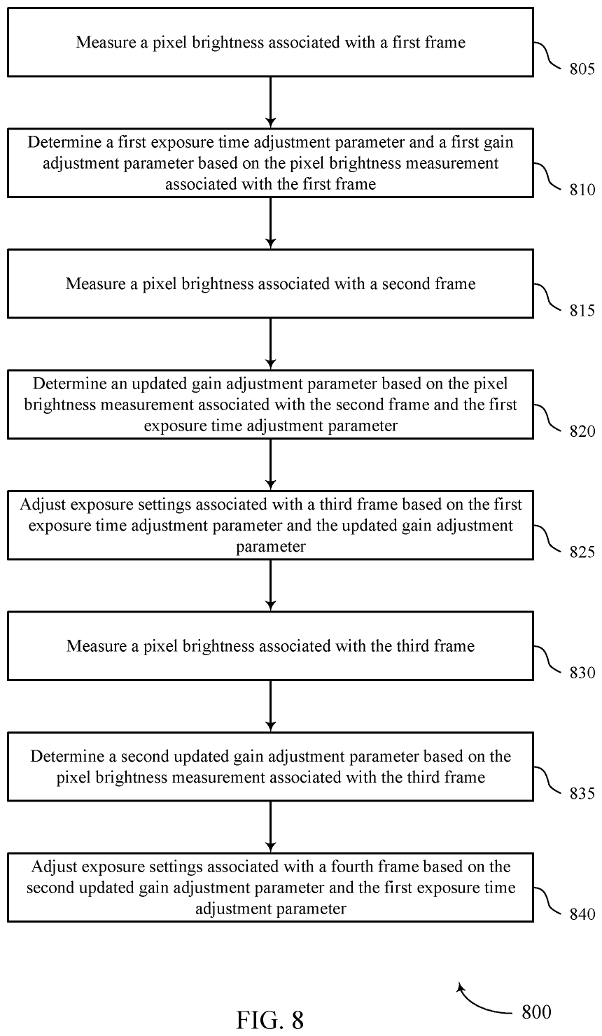

FIG. 8 shows a flowchart illustrating a method 800 that supports faster AEC in accordance with aspects of the present disclosure. The operations of method 800 may be implemented by a device or its components as described herein. For example, the operations of method 800 may be performed by an AEC manager as described with reference to FIGS. 4 through 5. In some examples, a device may execute a set of instructions to control the functional elements of the device to perform the functions described below. Additionally or alternatively, a device may perform aspects of the functions described below using special-purpose hardware.

At 805, the device may measure a pixel brightness associated with a first frame. The operations of 805 may be performed according to the methods described herein. In some examples, aspects of the operations of 805 may be performed by an image sensor as described with reference to FIGS. 4 through 5.

At 810, the device may determine a first exposure time adjustment parameter and a first gain adjustment parameter based on the pixel brightness measurement associated with the first frame. The operations of 810 may be performed according to the methods described herein. In some examples, aspects of the operations of 810 may be performed by an exposure settings manager as described with reference to FIGS. 4 through 5.

At 815, the device may measure a pixel brightness associated with a second frame. The operations of 815 may be performed according to the methods described herein. In some examples, aspects of the operations of 815 may be performed by an image sensor as described with reference to FIGS. 4 through 5.

At 820, the device may determine an updated gain adjustment parameter based on the pixel brightness measurement associated with the second frame and the first exposure time adjustment parameter. The operations of 820 may be performed according to the methods described herein. In some examples, aspects of the operations of 820 may be performed by a gain adjustment manager as described with reference to FIGS. 4 through 5.

At 825, the device may adjust exposure settings associated with a third frame based on the first exposure time adjustment parameter and the updated gain adjustment parameter. The operations of 825 may be performed according to the methods described herein. In some examples, aspects of the operations of 825 may be performed by an exposure settings manager as described with reference to FIGS. 4 through 5.

At 830, the device may measure a pixel brightness associated with the third frame. The operations of 830 may be performed according to the methods described herein. In some examples, aspects of the operations of 830 may be performed by an image sensor as described with reference to FIGS. 4 through 5.

At 835, the device may determine a second updated gain adjustment parameter based on the pixel brightness measurement associated with the third frame. The operations of 835 may be performed according to the methods described herein. In some examples, aspects of the operations of 835 may be performed by a gain adjustment manager as described with reference to FIGS. 4 through 5.

At 840, the device may adjust exposure settings associated with a fourth frame based on the second updated gain adjustment parameter and the first exposure time adjustment parameter. The operations of 840 may be performed according to the methods described herein. In some examples, aspects of the operations of 840 may be performed by an exposure settings manager as described with reference to FIGS. 4 through 5.

It should be noted that the methods described above describe possible implementations, and that the operations and the steps may be rearranged or otherwise modified and that other implementations are possible. Furthermore, aspects from two or more of the methods may be combined.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for adjusting exposure at a camera of a device, comprising:
measuring a pixel brightness associated with a first frame;
determining a first exposure time adjustment parameter and a first gain adjustment parameter based at least in part on the pixel brightness measurement associated with the first frame;
measuring a pixel brightness associated with a second frame;
determining an updated gain adjustment parameter based at least in part on the pixel brightness measurement associated with the second frame and the first exposure time adjustment parameter; and
adjusting exposure settings associated with a third frame based at least in part on the first exposure time adjustment parameter and the updated gain adjustment parameter.

2. The method of claim 1, wherein determining the updated gain adjustment parameter further comprises:
determining a second gain adjustment parameter and a second exposure time adjustment parameter based at least in part on the pixel brightness measurement associated with the second frame;
determining a ratio of the first exposure time adjustment parameter and the second exposure time adjustment parameter; and
multiplying the second gain adjustment parameter by the ratio, wherein the updated gain adjustment parameter comprises a result of the multiplication.

3. The method of claim 1, further comprising:
measuring a pixel brightness associated with the third frame;
determining a second updated gain adjustment parameter based at least in part on the pixel brightness measurement associated with the third frame; and
adjusting exposure settings associated with a fourth frame based at least in part on the second updated gain adjustment parameter and the first exposure time adjustment parameter.

4. The method of claim 1, further comprising:
determining a second exposure time adjustment parameter based at least in part on the pixel brightness measurement associated with the second frame; and
adjusting exposure settings associated with a fourth frame based at least in part on the second exposure time adjustment parameter and the updated gain adjustment parameter.

5. The method of claim 1, wherein adjusting the exposure settings associated with the third frame further comprises:
determining, by a processing component, the first exposure time adjustment parameter during the first frame;
determining, by the processing component, the updated gain adjustment parameter during the second frame; and
determining, by the processing component, one or more exposure setting values for the third frame based at least in part on the first exposure time adjustment parameter and the updated gain adjustment parameter, wherein the exposure settings are adjusted based at least in part on the one or more determined exposure setting values.

6. The method of claim 5, further comprising:
signaling, by the processing component, the one or more determined exposure setting values to the camera of the device, wherein the camera adjusts the exposure settings for the third frame based at least in part on the one or more determined exposure setting values.

7. The method of claim 5, wherein the one or more exposure setting values comprise a gain value, an exposure time value, or both.

8. The method of claim 5, further comprising:
signaling, by the camera, one or more pixel values to the processor based at least in part on the pixel brightness measurement associated with the first frame and the pixel brightness measurement associated with the second frame, wherein the first exposure time adjustment parameter and the updated gain adjustment parameter are determined by the processor based at least in part on the one or more pixel values.

9. An apparatus for adjusting exposure at a camera of a device, comprising:
a processor,
memory in electronic communication with the processor; and
instructions stored in the memory and executable by the processor to cause the apparatus to:
measure a pixel brightness associated with a first frame;
determine a first exposure time adjustment parameter and a first gain adjustment parameter based at least in part on the pixel brightness measurement associated with the first frame;
measure a pixel brightness associated with a second frame;
determine an updated gain adjustment parameter based at least in part on the pixel brightness measurement associated with the second frame and the first exposure time adjustment parameter; and
adjust exposure settings associated with a third frame based at least in part on the first exposure time adjustment parameter and the updated gain adjustment parameter.

10. The apparatus of claim 9, wherein the instructions to determine the updated gain adjustment parameter further are executable by the processor to cause the apparatus to:
determine a second gain adjustment parameter and a second exposure time adjustment parameter based at least in part on the pixel brightness measurement associated with the second frame;
determine a ratio of the first exposure time adjustment parameter and the second exposure time adjustment parameter; and
multiply the second gain adjustment parameter by the ratio, wherein the updated gain adjustment parameter comprises a result of the multiplication.

11. The apparatus of claim 9, wherein the instructions are further executable by the processor to cause the apparatus to:
measure a pixel brightness associated with the third frame;
determine a second updated gain adjustment parameter based at least in part on the pixel brightness measurement associated with the third frame; and
adjust exposure settings associated with a fourth frame based at least in part on the second updated gain adjustment parameter and the first exposure time adjustment parameter.

12. The apparatus of claim 9, wherein the instructions are further executable by the processor to cause the apparatus to:
determine a second exposure time adjustment parameter based at least in part on the pixel brightness measurement associated with the second frame; and
adjust exposure settings associated with a fourth frame based at least in part on the second exposure time adjustment parameter and the updated gain adjustment parameter.

13. The apparatus of claim 9, wherein the instructions to adjust the exposure settings associated with the third frame further are executable by the processor to cause the apparatus to:
determine, by a processing component, the first exposure time adjustment parameter during the first frame;
determine, by the processing component, the updated gain adjustment parameter during the second frame; and
determine, by the processing component, one or more exposure setting values for the third frame based at least in part on the first exposure time adjustment parameter and the updated gain adjustment parameter, wherein the exposure settings are adjusted based at least in part on the one or more determined exposure setting values.

14. The apparatus of claim 13, wherein the instructions are further executable by the processor to cause the apparatus to:
signal, by the processing component, the one or more determined exposure setting values to the camera of the device, wherein the camera adjusts the exposure settings for the third frame based at least in part on the one or more determined exposure setting values.

15. The apparatus of claim 13, wherein the one or more exposure setting values comprise a gain value, an exposure time value, or both.

16. The apparatus of claim 13, wherein the instructions are further executable by the processor to cause the apparatus to:
signal, by the camera, one or more pixel values to the processor based at least in part on the pixel brightness measurement associated with the first frame and the pixel brightness measurement associated with the second frame, wherein the first exposure time adjustment parameter and the updated gain adjustment parameter are determined by the processor based at least in part on the one or more pixel values.

17. An apparatus for adjusting exposure at a camera of a device, comprising:
means for measuring a pixel brightness associated with a first frame;
means for determining a first exposure time adjustment parameter and a first gain adjustment parameter based at least in part on the pixel brightness measurement associated with the first frame;
means for measuring a pixel brightness associated with a second frame;
means for determining an updated gain adjustment parameter based at least in part on the pixel brightness measurement associated with the second frame and the first exposure time adjustment parameter; and
means for adjusting exposure settings associated with a third frame based at least in part on the first exposure time adjustment parameter and the updated gain adjustment parameter.

18. The apparatus of claim 17, wherein the means for determining the updated gain adjustment parameter further comprises:
means for determining a second gain adjustment parameter and a second exposure time adjustment parameter based at least in part on the pixel brightness measurement associated with the second frame;
means for determining a ratio of the first exposure time adjustment parameter and the second exposure time adjustment parameter; and
means for multiplying the second gain adjustment parameter by the ratio, wherein the updated gain adjustment parameter comprises a result of the multiplication.

19. The apparatus of claim 17, further comprising:
means for measuring a pixel brightness associated with the third frame;
means for determining a second updated gain adjustment parameter based at least in part on the pixel brightness measurement associated with the third frame; and
means for adjusting exposure settings associated with a fourth frame based at least in part on the second updated gain adjustment parameter and the first exposure time adjustment parameter.

20. The apparatus of claim 17, further comprising:
means for determining a second exposure time adjustment parameter based at least in part on the pixel brightness measurement associated with the second frame; and
means for adjusting exposure settings associated with a fourth frame based at least in part on the second exposure time adjustment parameter and the updated gain adjustment parameter.
